(19) United States
(12) Patent Application Publication
(10) Pub. No.: US 2026/0267985 A1
(43) Pub. Date: Sep. 10, 2026

(54) EVALUATION DEVICE, COMPANY TERMINAL, EVALUATION SYSTEM, EVALUATION METHOD, AND RECORDING MEDIUM

(71) Applicant: NEC Corporation, Minato-ku, Tokyo (JP)

(72) Inventors: Io FURUYAMA, Tokyo (JP); Kazuaki NAKAJIMA, Tokyo (JP)

(73) Assignee: NEC Corporation, Minato-ku, Tokyo (JP)

(21) Appl. No.: 18/871,650

(22) PCT Filed: Sep. 29, 2022
(86) PCT No.: PCT/JP2022/036511

§ 371 Date: Dec. 4, 2024

(51) Int. Cl. G06F 21/57

(52) U.S. Cl. CPC G06F 21/577

(57) ABSTRACT

An evaluation device includes: a memory storing instructions; and at least one processor configured to execute the instructions to: acquire a trust evaluation indicator for evaluating trustworthiness corresponding to a user business operator; acquire apparatus information about a network apparatus to be evaluated; inspect the network apparatus based on the trust evaluation indicator by using the apparatus information; evaluate the trustworthiness based on a result of the inspection; and output a result of the evaluation on the trustworthiness.

### TECHNICAL FIELD

The present disclosure relates to an evaluation device, a company terminal, an evaluation system, an evaluation method, and a recording medium.

### BACKGROUND ART

Performance related to safety and reliability of a network apparatus delivered from a developer of the network apparatus is uniformly evaluated in accordance with a predetermined guideline.

PTL 1, for example, discloses a technique for deriving a vulnerability score by individually quantifying each vulnerability of at least one network apparatus based on a result of a fact that the network apparatus has undergone an attack.

### CITATION LIST

### Patent Literature

PTL 1: JP 2021-064046 A

### SUMMARY OF INVENTION

### Technical Problem

In an invention described in PTL 1, however, a vulnerability score is calculated in accordance with a determination criterion at a stand point on a side of those who evaluate vulnerability. For trustworthiness (reliability) of a network apparatus, its determination criterion is different depending on a stand point and a way of thinking of an evaluator, and using a uniform criterion makes it difficult to perform appropriate evaluation. It is necessary to perform evaluation based on an indicator considered by a user business operator introducing a network apparatus into a system.

An example of an object of the present disclosure is to provide an evaluation device that makes it possible to evaluate trustworthiness required by each user business operator.

### Solution to Problem

An evaluation device according to an aspect of the present disclosure includes: an evaluation indicator acquiring means for acquiring a trust evaluation indicator for evaluating trustworthiness corresponding to a user business operator; an apparatus information acquiring means for acquiring apparatus information about a network apparatus to be evaluated; an inspecting means for using the apparatus information to inspect the network apparatus based on the trust evaluation indicator; an evaluating means for evaluating the trustworthiness based on a result of the inspection; and an output means for outputting a result of the evaluation on the trustworthiness.

An evaluation system according to the aspect of the present disclosure includes: an apparatus information storage device that stores apparatus information about the network apparatus; and the evaluation device described above, in which the evaluation device includes: an evaluation indicator acquiring means for acquiring a trust evaluation indicator for evaluating trustworthiness corresponding to a user business operator; an information acquiring means for acquiring apparatus information about a network apparatus to be evaluated from the apparatus information storage device; an inspecting means for using the apparatus information to inspect the network apparatus based on the trust evaluation indicator; an evaluating means for evaluating the trustworthiness based on a result of the inspection; and an output means for issuing a certificate for certifying a result of the evaluation on the trustworthiness and storing the certificate in the apparatus information storage device with an electronic signature attached to the certificate.

An evaluation method according to the aspect of the present disclosure is performed by a computer, the method includes: acquiring a trust evaluation indicator for evaluating trustworthiness corresponding to a user business operator; acquiring apparatus information about a network apparatus to be evaluated; using the apparatus information to inspect the network apparatus based on the trust evaluation indicator; evaluating the trustworthiness based on a result of the inspection; and outputting a result of the evaluation on the trustworthiness.

A recording medium according to the aspect of the present disclosure stores a program causing a computer to execute: acquiring a trust evaluation indicator for evaluating trustworthiness corresponding to a user business operator; acquiring apparatus information about a network apparatus to be evaluated; using the apparatus information to inspect the network apparatus based on the trust evaluation indicator; evaluating the trustworthiness based on a result of the inspection; and outputting a result of the evaluation on the trustworthiness.

### Advantageous Effects of Invention

An example of an effect of the present disclosure is to make it possible to provide an evaluation device that makes it possible to evaluate trustworthiness required by each user business operator.

### BRIEF DESCRIPTION OF DRAWINGS

FIG. 1 is a block diagram illustrating a configuration of an evaluation system according to a first example embodiment.

FIG. 2 is a diagram illustrating a hardware configuration in which the evaluation device according to the first example embodiment is achieved by a computer device and its peripheral device.

FIG. 3 is a flowchart illustrating the evaluation system according to the first example embodiment.

### EXAMPLE EMBODIMENT

Next, an example embodiment will now be described herein in detail with reference to the accompanying drawings.

### First Example Embodiment

An evaluation device 100 according to a first example embodiment is, for example, a device for evaluating trustworthiness indicating reliability of a specific network apparatus for a user business operator considering introduction of the specific network apparatus into its own system. The evaluation device 100 may evaluate trustworthiness not only when the user business operator newly purchases a specific network apparatus, but also, for example, at a timing when a configuration is changed such as when a piece of software for the network apparatus undergoes version upgrading. A network apparatus refers to, for example, an apparatus for relaying or transferring data on a network, such as a router, a hub, a gateway, or a switch.

An evaluation system 10 according to the present example embodiment includes the evaluation device 100, a company terminal 200 of a user business operator requesting the evaluation device 100 for inspecting a network apparatus, and an apparatus information storage device 300 that stores apparatus information about each network apparatus. The apparatus information storage device 300 is owned by a platform business operator managing apparatus information about each network apparatus. For example, the user business operator may request a third-party evaluation organization for evaluating trustworthiness of a network apparatus via the platform business operator.

The company terminal 200 includes an evaluation indicator transmitting unit 201 for transmitting a trust evaluation indicator adopted by the user business operator, a verifying unit 202, and a determining unit 203.

The apparatus information storage device 300 stores at least configuration information and inspection information about a network apparatus as apparatus information. The apparatus information stored in the apparatus information storage device 300 undergoes updating in accordance with version upgrading of the network apparatus.

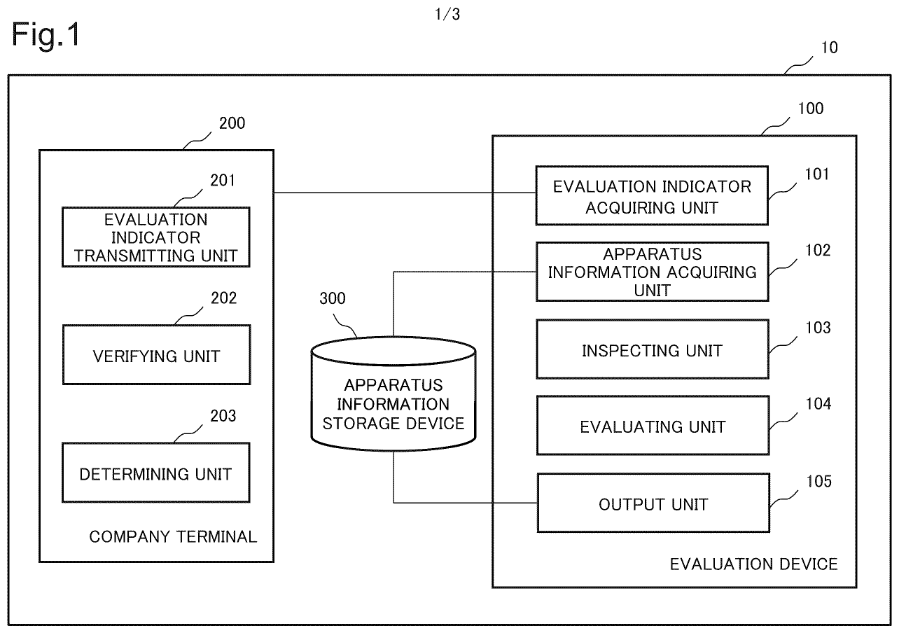

FIG. 1 is a block diagram illustrating a configuration of the evaluation device 100 according to the first example embodiment. Referring to FIG. 1, the evaluation device 100 includes an evaluation indicator acquiring unit 101, an apparatus information acquiring unit 102, an inspecting unit 103, an evaluating unit 104, and an output unit 105. The evaluation device 100 that is an essential configuration in the present example embodiment will now be described herein in detail.

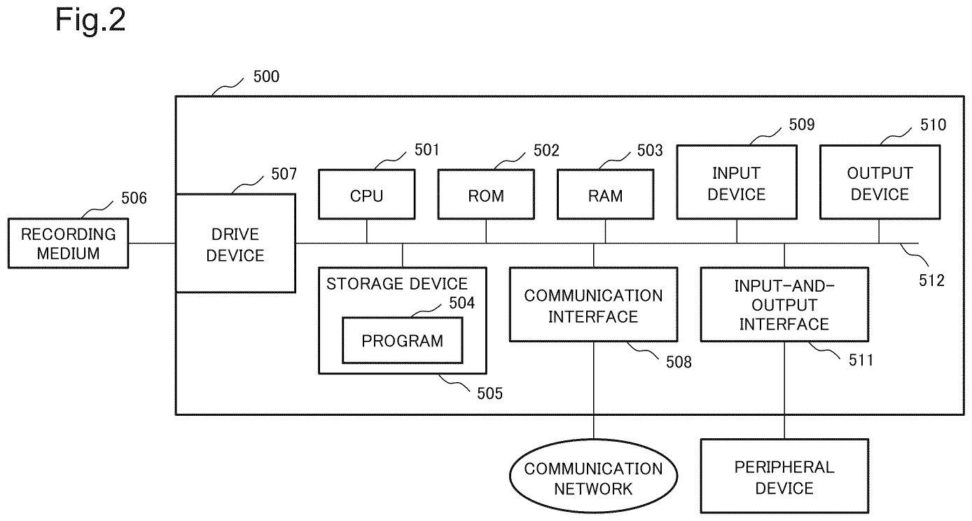

FIG. 2 is a diagram illustrating an example of a hardware configuration in which the evaluation device 100 according to the first example embodiment of the present disclosure is achieved by a computer device 500 including a processor. As illustrated in FIG. 2, the evaluation device 100 includes a central processing unit (CPU) 501, a memory including a read only memory (ROM) 502 and a random access memory (RAM) 503, for example, a storage device 505 such as a hard disk that stores a program 504, a communication interface (I/F) 508 for network connection, and an input-and-output interface 511 for inputting and outputting data. In the first example embodiment, a trust evaluation index acquired by the evaluation indicator acquiring unit 101 is inputted into the evaluation device 100 via the communication I/F 508, for example.

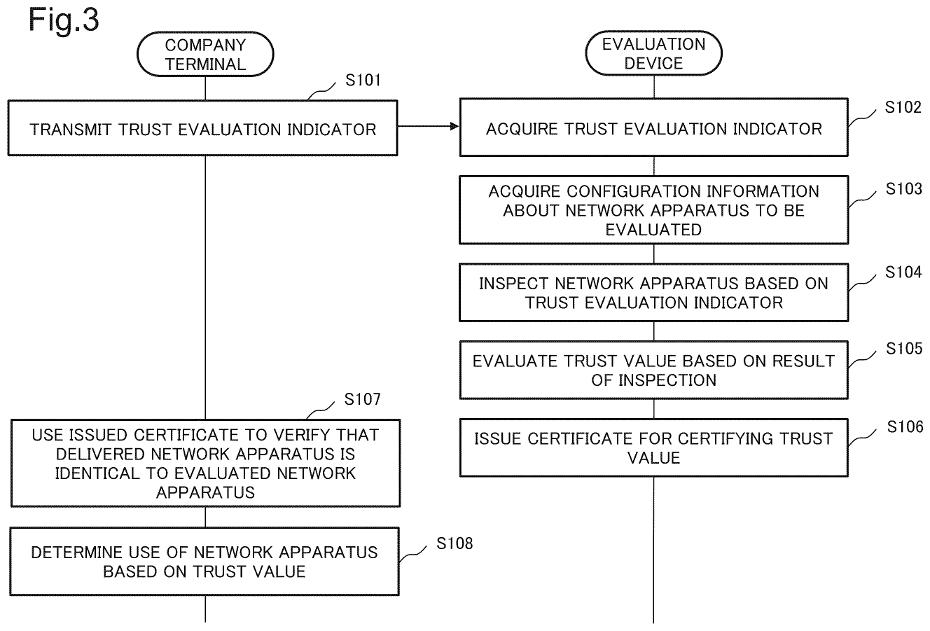

The CPU 501 allows an operating system to operate to wholly control the evaluation device 100 according to the first example embodiment of the present invention. The CPU 501 reads programs and data from a recording medium 506 mounted on a drive device 507 and outputs the read programs and data to the memory, for example. The CPU 501 functions as all of or a part of the evaluation indicator acquiring unit 101, the apparatus information acquiring unit 102, the inspecting unit 103, the evaluating unit 104, and the output unit 105 according to the first example embodiment, and executes processing or commands in a flowchart illustrated in FIG. 3 described later based on the programs.

The recording medium 506 is an optical disk, a flexible disk, a magnetic optical disk, an external hard disk, or a semiconductor memory, for example. The recording medium serving as a part of the storage device is a non-volatile storage device, in which the programs are recorded. The programs may be downloaded from a non-illustrated external computer coupled to a communication network.

An input device 509 is achieved by a mouse, a keyboard, and built-in key buttons, for example, and is used for input operation. The input device 509 is not limited to include a mouse, a keyboard, and built-in key buttons, and may include a touch panel, for example. An output device 510 is achieved by a display, for example, and is used to confirm an output.

As described above, the first example embodiment illustrated in FIG. 1 is achieved by a computer and hardware as illustrated in FIG. 2. However, the achievement means for the components included in the evaluation device 100 illustrated in FIG. 1 is not limited to the configuration described above. The evaluation device 100 may be achieved by one physically coupled device, or may be achieved by a plurality of devices in which two or more physically separated devices are coupled to each other in a wired or wireless manner. For example, the input device 509 and the output device 510 may be coupled to the computer device 500 via a network. It is also possible to configure the evaluation device 100 according to the first example embodiment illustrated in FIG. 1 by using cloud computing, for example.

In FIG. 1, the evaluation indicator acquiring unit 101 is a means for acquiring a trust evaluation indicator for evaluating trustworthiness corresponding to a user business operator. In the present example embodiment, the evaluation indicator acquiring unit 101 acquires a trust evaluation indicator from the evaluation indicator transmitting unit 201 via the network.

Trustworthiness refers to reliability of a whole network including a plurality of network apparatuses, and to, for example, reliability for maintaining stable operation of the whole network. A trust evaluation indicator represents a viewpoint for evaluating trustworthiness, and includes presence or absence of an unauthorized function of a network apparatus, an inspection situation, and a visualization situation of configuration information.

Examples of the trust evaluation indicator include those indicated as (1) to (4) and described below. (1) Presence or absence of a back door, (2) inspection situation of risk assessment, (3) visualization of a developer of a network apparatus, and (4) inspection situation on a supply chain.

In the examples (1) to (4) described above, an evaluation criterion for a trust evaluation indicator may be different. For example, for (1) presence or absence of a back door, there may be a case where a fact that neither function nor processing serving as a back door is included by analyzing a binary code is used as an evaluation criterion, or there may be a case where a fact that no back door is included by analyzing a source code is used as an evaluation criterion. A back door refers to a hidden function or an additional function that is not recognized by a user, and to an unauthorized function in a piece of software.

For (2) inspection situation of risk assessment, there may be a case where a fact that detected vulnerability is wholly eliminated is used as an evaluation criterion, or there may be a case where an evaluation criterion is satisfied when a risk and a countermeasure against vulnerability are grasped. Each of such evaluation criteria as those described above may be set based on a degree of influence on a user business operator when a system in which a network apparatus is introduced has stopped. For example, when information leakage of confidential information or a risk related to human life occurs when a system has stopped, a more rigorous evaluation criterion may be applied. Vulnerability refers to a defect on security, which occurs in a piece of hardware or a piece of software in a network apparatus due to a design error or a failure in a program, for example, and includes information that is disclosed externally.

For (3) visualization of a developer of a network apparatus, there may be a case where a fact that all attributes of a developer are clarified is used as an evaluation criterion, or there may be a case where an evaluation criterion is satisfied when a portion where no developer information is known is grasped. There may be a case where a fact that an attribute of a developer is a specific country or business operator or is not a specific country or business operator is used as an evaluation criterion.

For (4) inspection situation on a supply chain, there may be a case where a fact that a result of inspection on all business operators on a supply chain of network apparatuses is clarified is used as an evaluation criterion, or there may be a case where a fact that a portion where there is no result of inspection or a portion where there is no inspection performed is grasped is used as an evaluation criterion. Instead of a final product, a number of times of inspection at a development stage may be incorporated into a trust evaluation indicator.

A trust evaluation indicator refers to an evaluation indicator for evaluating trustworthiness of a network apparatus, which meets a need of a user business operator. For example, a trust evaluation indicator refers to an evaluation indicator for an item of trustworthiness described above such as “presence or absence of a back door”. A trust evaluation indicator may be a single evaluation indicator, a set of a plurality of evaluation indicators, a combination of a plurality of evaluation indicators, or an evaluation indicator calculated by using a plurality of evaluation indicators such as an average. A user business operator may create a trust evaluation indicator in accordance with trustworthiness required for a network including network apparatuses to be introduced, or may acquire a trust evaluation indicator from a third-party organization or a platform business operator. The evaluation indicator acquiring unit 101 outputs the acquired trust evaluation indicator to the inspecting unit 103.

The apparatus information acquiring unit 102 is a means for acquiring apparatus information about a network apparatus to be evaluated. For example, the apparatus information acquiring unit 102 acquires apparatus information about a network apparatus to be evaluated from the apparatus information storage device 300. Apparatus information refers to information necessary for evaluating trustworthiness of a network apparatus, and includes configuration information and inspection information. In the apparatus information storage device 300, for example, configuration information and inspection information are stored in association with each other for each network apparatus.

Configuration information refers to, for example, hardware information and software information about the network apparatus. Hardware information includes, for example, developer information, model numbers of a chip, a substrate, and a port, for example, forming a piece of hardware, and an identifier assigned to the piece of hardware. Software information includes developer information, names of pieces of software such as an operating system (OS) that performs processing for the piece of hardware and a library or an application, version information of the pieces of software, and code information of the pieces of software. For configuration information, the information is updated at a timing when configuration information is updated, such as a timing for version upgrading of software.

Inspection information refers to information related to a result of inspection performed based on configuration information about a network apparatus by a business operator on a supply chain from procurement to delivery of parts used in the network apparatus. Inspection information includes inspection related to a back door described above or inspection related to risk assessment. When apparatus information about a network apparatus to be evaluated is acquired, the apparatus information acquiring unit 102 outputs the acquired apparatus information to the inspecting unit 103.

The inspecting unit 103 is a means for using apparatus information to inspect a network apparatus based on a trust evaluation indicator. A specific inspection method is as follows. That is, the inspecting unit 103 creates an inspection item for a network apparatus for evaluating trustworthiness of a network based on configuration information and a trust evaluation indicator. For example, the inspecting unit 103 creates an inspection item for evaluating a trust evaluation indicator for a network apparatus to be evaluated.

For example, when a trust evaluation indicator is presence or absence of a back door, the inspecting unit 103 creates, as an inspection item, an item for inspecting a possibility of a back door for an apparatus to be inspected. The inspecting unit 103 may create a plurality of inspection items for one trust evaluation indicator, or may create one inspection item for a plurality of trust evaluation indicators.

Next, for each created inspection item, the inspecting unit 103 inspect the network apparatus using the evaluation criterion for the trust evaluation indicator to. The inspecting unit 103 may indicate a result of the inspection for each trust evaluation indicator with a binary value of 0 or 100, or with a specific rank ranging from A to C, for example. The inspecting unit 103 may indicate a result of the inspection for each trust evaluation indicator with a numerical value (score) ranging from 0 to 100%, for example.

The evaluating unit 104 is a means for evaluating the trustworthiness based on the result of the inspection. The evaluating unit 104 comprehensively evaluates the trustworthiness of the network apparatus based on each result of the inspection on the trust evaluation indicator.

For example, the evaluating unit 104 calculates a total value or an average value of results of inspection on trust evaluation indicators to evaluate trustworthiness. The evaluating unit 104 may determine that trustworthiness is not satisfied when a result of inspection on any of trust evaluation indicators is 0, or may determine that trustworthiness is not satisfied when a result of inspection on a predetermined trust evaluation indicator is equal to or less than a predetermined value. However, an evaluation method for trustworthiness, which is performed by the evaluating unit 104, is not limited to those described above.

The output unit 105 is a means for outputting a result of the evaluation on the trustworthiness of the network apparatus. The output unit 105 causes, for example, the output device 510 such as a display to display the result of the evaluation on the trustworthiness. The output unit 105 may output the result of the evaluation on the trustworthiness of the network apparatus to the user business operator. The output unit 105 may issue a certificate for certifying the result of the evaluation on the trustworthiness. A certificate is issued to a third party, including the user business operator, to certify a result of evaluation on trustworthiness of a network apparatus. In this case, the output unit 105 stores the certificate describing the result of the evaluation on the trustworthiness, to which an electronic signature is attached, in the apparatus information storage device 300 together with a public key.

Next, a configuration of the company terminal 200 will now be described herein. When the certificate of the result of the evaluation on the trustworthiness is issued by the output unit 105, the company terminal 200 performs processing for determining use of the network apparatus. The verifying unit 202 is a means for verifying, after a network apparatus is delivered, whether the delivered network apparatus is identical to the evaluated network apparatus, by using the issued certificate. Specifically, the verifying unit 202 decodes, by using the public key, a hash value of the electronic signature included in the certificate stored in the apparatus information storage device 300, compares the decoded hash value with a hash value distributed from the developer of the network apparatus, and verifies its identity with the network apparatus delivered from the developer. When the two network apparatuses are not identical to each other, the verifying unit 202 requests the developer for delivering a network apparatus that is identical to the evaluated network apparatus.

The determining unit 203 is a means for determining use of the network apparatus based on the result of the evaluation on the trustworthiness. The determining unit 203 may determine use of the network apparatus when a value of the result of the evaluation on the trustworthiness is equal to or greater than a predetermined threshold value. The determining unit 203 may determine use of a network apparatus with a result of evaluation on trustworthiness, which is determined to be highest, from among a plurality of network apparatuses.

Operation of the evaluation device 100 configured as described above will now be described herein with reference to the flowchart illustrated in FIG. 3.

FIG. 3 is a flowchart illustrating an outline of operation of the evaluation device 100 according to the first example embodiment. The processing in accordance with this flowchart may be executed based on program control by the processor described above.

As illustrated in FIG. 3, the evaluation indicator transmitting unit 201 in the company terminal 200 first transmits a trust evaluation indicator for evaluating trustworthiness to the evaluation device 100 (step S101). Next, the evaluation indicator acquiring unit 101 in the evaluation device 100 acquires the trust evaluation indicator from the company terminal 200 (step S102). Next, the apparatus information acquiring unit 102 acquires apparatus information about a network apparatus to be evaluated (step S103). Next, the inspecting unit 103 inspects the network apparatus based on the trust evaluation indicator (step S104). Next, the evaluating unit 104 evaluates the trustworthiness based on a result of the inspection (step S105). Next, the output unit 105 issues a certificate for certifying a result of the evaluation on the trustworthiness (step S106).

After a network apparatus is delivered, on the other hand, the verifying unit 202 in the company terminal 200 verifies, by using the issued certificate, whether the delivered network apparatus is identical to the evaluated network apparatus (step S107). After the verification, the determining unit 203 finally determines use of the network apparatus based on the result of the evaluation on the trustworthiness (step S108). Thus, the evaluation device 100 ends its operation.

In the evaluation device 100 according to the present example embodiment, the evaluation indicator acquiring unit 101 acquires a trust evaluation indicator from a user business operator, the inspecting unit 103 inspects a network apparatus based on the trust evaluation indicator, and the evaluating unit 104 evaluates its trustworthiness based on a result of the inspection. As a result, it is possible to evaluate trustworthiness required by the user business operator.

In the present example embodiment, the output unit 105 issues a certificate with an electronic signature attached to the result of the evaluation on the trustworthiness. As a result, it is possible to secure validity of the result of the evaluation on the trustworthiness. The user business operator who has acquired the certificate on trustworthiness is able to utilize the valid result of the evaluation on the trustworthiness, making it possible to consider introduction of a network apparatus based on a highly reliable result of evaluation on trustworthiness.

A modification example of the present example embodiment will now be described herein by focusing on those that are different from those in the first example embodiment. In the first example embodiment, the evaluation indicator acquiring unit 101 has acquired a trust evaluation indicator from a user business operator. In the modification example, on the other hand, the evaluation indicator acquiring unit 101 may evaluate validity of a trust evaluation indicator acquired from a user business operator, and may use the trust evaluation indicator when the trust evaluation indicator is valid. That is, the evaluation indicator acquiring unit 101 outputs the trust evaluation indicator to the inspecting unit 103 when the trust evaluation indicator acquired from the user business operator is valid.

The evaluation indicator acquiring unit 101 may acquire a trust evaluation indicator created by analyzing a trend of a trust evaluation indicator adopted by another business operator similar in scale, business aspect, industry, or industry type to the user business operator. Such a trust evaluation indicator as described above is a trust evaluation indicator created by analyzing a trend per a scale, a business aspect, an industry, or an industry type of each user company based on a trust evaluation indicator submitted from another user business operator, and is stored in, for example, the storage device 505. As an example of a created trust evaluation indicator, for example, when a business operator in an identical industry has evaluated trustworthiness by using a specific trust evaluation indicator at a ratio equal to or more than a predetermined value, the trust evaluation indicator is included. More specifically, when a specific industry places importance on visualization of a developer of a network apparatus, and a fact that an attribute of the developer is not a specific country is used as an evaluation criterion, such a trust evaluation indicator is included. The evaluation indicator acquiring unit 101 may present and adopt, when a trust evaluation indicator acquired from a user business operator is invalid, the trust evaluation indicator described above to the user business operator.

While the invention has been particularly shown and described with reference to an exemplary embodiment thereof, the invention is not limited to the exemplary embodiment. It will be understood by those of ordinary skill in the art that various changes in form and details may be made therein without departing from the spirit and scope of the present invention as defined by the claims.

For example, although a plurality of types of operation are described in order in the form of flowchart, the order of those described does not limit the order of executing the plurality of types of operation. Therefore, when each example embodiment is to be implemented, it is possible to change the order of the plurality of types of operation within a range where there will be no interference in content. At step S106 in the flowchart illustrated in FIG. 3, the output unit 105 has issued a certificate for certifying a result of evaluation on trustworthiness. However, the output unit 105 may simply output a result of evaluation on trustworthiness to the output device 510. In this case, no subsequent steps in the processing is performed in the company terminal 200.

### REFERENCE SIGNS LIST

10 Evaluation system
100 Evaluation device
101 Evaluation indicator acquiring unit
102 Apparatus information acquiring unit
103 Inspecting unit
104 Evaluating unit
105 Output unit
200 Company terminal
300 Apparatus information storage device

What is claimed is:

1. An evaluation device comprising:
a memory storing instructions; and
at least one processor configured to execute the instructions to:
acquire a trust evaluation indicator for evaluating trustworthiness corresponding to a user business operator;
an acquire apparatus information about a network apparatus to be evaluated;
inspect the network apparatus based on the trust evaluation indicator by using the apparatus information;
evaluate the trustworthiness based on a result of the inspection; and
output a result of the evaluation on the trustworthiness.

2. The evaluation device according to claim 1, wherein
the at least one processor is further configured to execute the instructions to:
issue a certificate for certifying the result of the evaluation on the trustworthiness.

3. The evaluation device according to claim 1, wherein
the at least one processor is further configured to execute the instructions to:
acquire a trust evaluation indicator from the user business operator.

4. The evaluation device according to claim 3, wherein
the at least one processor is further configured to execute the instructions to:
evaluate validity of the trust evaluation indicator acquired from the user business operator, and
inspect the network apparatus based on the trust evaluation indicator when the trust evaluation indicator is valid.

5. The evaluation device according to claim 1, wherein the trust evaluation indicator is a trust evaluation indicator created by analyzing a trend of a trust evaluation indicator adopted by another business operator similar in scale, business aspect, industry, or industry type to the user business operator.

6. The evaluation device according to claim 1, wherein the apparatus information includes configuration information and inspection information about the network apparatus.

7. A company terminal comprising:
a memory storing instructions; and
at least one processor configured to execute the instructions to:
verify, based on the certificate issued by the evaluation device according to claim 2, whether a delivered network apparatus is identical to the evaluated network apparatus; and
determine, after the verification, use of the network apparatus based on the result of the evaluation on the trustworthiness.

8. An evaluation system comprising:
an apparatus information storage device that stores apparatus information about the network apparatus; and
an evaluation device, comprising:
a memory storing instructions; and
at least one processor configured to execute the instructions to:
an acquire a trust evaluation indicator for evaluating trustworthiness corresponding to a user business operator;
acquire apparatus information about a network apparatus to be evaluated from the apparatus information storage device;
inspect the network apparatus based on the trust evaluation indicator by using the apparatus information;
evaluate the trustworthiness based on a result of the inspection;
issue a certificate for certifying a result of the evaluation on the trustworthiness; and
store the certificate in the apparatus information storage device with an electronic signature attached to the certificate.

9. An evaluation method performed by a computer, the method comprising:
acquiring a trust evaluation indicator for evaluating trustworthiness corresponding to a user business operator;
acquiring apparatus information about a network apparatus to be evaluated;
inspecting the network apparatus based on the trust evaluation indicator by using the apparatus information;
evaluating the trustworthiness based on a result of the inspection; and
outputting a result of the evaluation on the trustworthiness.

10. (canceled)
